(19) United States
(12) Patent Application Publication
(10) Pub. No.: US 2023/0136430 A1
(43) Pub. Date: May 4, 2023

(54) BATTERY INCLUDING ENCLOSURE FOR BATTERY CELL GROUPS

(71) Applicant: GM GLOBAL TECHNOLOGY OPERATIONS LLC, Detroit, MI (US)

(72) Inventors: Rebecca A. Palmer, Ferndale, MI (US); Hunter G. Rimatzki, Clawson, MI (US); Joseph B. Blumka, Clarkston, MI (US); Matthew Pernot, Imlay City, MI (US); Julian R. Sherborne, South Lyon, MI (US); Anil Yadav, Troy, MI (US); Scott W. Lananna, Detroit, MI (US)

(73) Assignee: GM GLOBAL TECHNOLOGY OPERATIONS LLC, Detroit, MI (US)

(21) Appl. No.: 17/513,280

(22) Filed: Oct. 28, 2021

(51) Int. Cl. H01M 50/209; H01M 10/48; H01M 10/613; H01M 10/653; H01M 50/289

(52) U.S. Cl. CPC H01M 50/209; H01M 10/482; H01M 10/613; H01M 10/653; H01M 50/289; H01M 2220/20

(57) ABSTRACT

A battery includes a housing having a base. A battery cell stack and an enclosure are supported on the base of the housing. The battery cell stack includes a plurality of battery cells physically separated into a first battery cell group and a second battery cell group. The enclosure includes first and second support walls respectively disposed on opposite first and second sides of the first battery cell group and a canopy extending between the first and second support walls, above the first battery cell group. The enclosure partially surrounds the first battery cell group on three sides and establishes a physical and thermal barrier between the first battery cell group and the second battery cell group.

### INTRODUCTION

The present disclosure relates to thermal management of battery systems and, more particularly, to battery systems including dynamic structural enclosures for containing thermal runaway conditions.

A battery is a device that converts chemical energy into electrical energy by means of electrochemical reduction-oxidation (redox) reactions. In secondary or rechargeable batteries, these electrochemical reactions are reversible, which allows the batteries to undergo multiple charging and discharge cycles. Electric vehicles, including hybrid electric vehicles, are powered by electric motors or generators that, in turn, are typically powered by onboard rechargeable batteries. Such batteries typically include multiple individual electrochemical cells (referred to herein as battery cells) arranged in series and/or parallel and positioned adjacent one another to form battery modules and/or battery packs that, when incorporated in a battery system of an electric vehicle, provide the vehicle with a combination of high voltage and high capacity.

Rechargeable batteries employed in electric vehicles internally generate heat under normal charging and discharge operations. To optimize the performance and life of such batteries, it is beneficial to implement cooling systems that effectively transfer heat away from the battery cells during operation to maintain the temperature of the battery cells within a desirable operating temperature range. Sometimes a battery cell may generate a greater amount of heat than can be effectively removed from the battery cell by the cooling system, which may cause the battery cell to enter a condition referred to as thermal runaway. During a thermal runaway event, the heat generated by the battery cell may be unbounded and may, in turn, cause adjacent battery cells to undergo thermal runaway, potentially initiating a cascading reaction that may spread through an entire battery system. In addition, battery cells undergoing thermal runaway may emit hot gases and/or particulate matter, and it may be desirable to protect other components of the battery system and the vehicle being powered by the battery system from exposure to such emissions.

To prevent thermal runaway propagation between adjacent battery cells or battery cell groups, thermal barriers may be positioned between the cells or groups to contain the heat generated during a thermal runaway event. To prevent accumulation of emissions from the battery cells, and to protect battery system components from exposure to such emissions, battery housings may include a venting system configured to direct and control the flow of emissions through and out of the battery system.

### SUMMARY

A battery is disclosed that comprises a housing having a longitudinal axis and including a base. A battery cell stack and an enclosure are supported on the base of the housing. The battery cell stack includes a plurality of battery cells stacked relative to one another along a thickness direction thereof. The plurality of battery cells is physically separated into a first battery cell group and a second battery cell group. The enclosure includes first and second support walls respectively disposed on opposite first and second sides of the first battery cell group and a canopy that extends between distal ends of the first and second support walls, above the first battery cell group. Proximal ends of the first and second support walls are supported on the base of the housing and the distal ends of the first and second support walls extend away from the base, above the plurality of battery cells. The enclosure defines an inner chamber within the housing. The enclosure partially surrounds the first battery cell group on three sides and establishes a physical and thermal barrier between the first battery cell group and the second battery cell group.

The canopy may include a first end and an opposite second end. The first end of the canopy may be fixedly attached to the distal end of the first support wall and the second end of the canopy may be fixedly attached to the distal end of the second support wall.

The proximal ends of the first and second support walls may be biased toward each other such that the first and second support walls exert pressure in a longitudinal direction respectively on the first and second sides of the first battery cell group.

The housing may include a top and at least one sidewall extending between the base and the top of the housing. A gap may be defined between the battery cell stack and the at least one sidewall of the housing. Emissions from the first battery cell group may be directed through the inner chamber in a transverse direction perpendicular to the longitudinal axis of the housing into the gap.

The first and second support walls and the canopy may be of unitary one-piece construction.

The canopy may include a corrugation that allows the canopy to stretch or compress in a longitudinal direction at the corrugation.

The first and second support walls are moveably supported on the base of the housing such that the first and second support walls are moveable in a longitudinal direction relative to one another on the base to accommodate volumetric changes in the plurality of battery cells.

The canopy may be coupled to the distal end of the first support wall and may extend from the distal end of the first support wall in a longitudinal direction parallel to the longitudinal axis of the housing to a free end. The free end of the canopy may be configured to pivot about the distal end of the first support wall between a closed position, in which the free end of the canopy is supported on the distal end of the second support wall, and an open position in which an opening is defined between the free end of the canopy and the distal end of the second support wall.

The distal end of the second support wall may include one of: a cantilever that extends in a longitudinal direction from the distal end of the second support wall toward the first support wall, a flange that extends in a longitudinal direction from the distal end of the second support wall away from the first support wall, or a hemmed end. In such case, when the canopy is in the closed position, the free end of the canopy may be supported on the cantilever, the flange, or the hemmed end.

The canopy may be biased toward the closed position and against the distal end of the second support wall. The canopy may be configured to transition from the closed position to the open position in response to a pressure increase within the inner chamber.

The housing may include a top and at least one sidewall extending between the base and the top of the housing. A plenum may be defined in the housing between an upper end of the battery cell stack and the top of the housing. When the canopy is in the open position, emissions from the first battery cell group may be directed from the inner chamber, through the opening, and into the plenum.

The plenum may be in fluid communication with a vent in the top of the housing. When the canopy is in the open position, the canopy may direct the emissions in the plenum to flow in a longitudinal direction parallel to the longitudinal axis of the housing toward the vent.

A battery is disclosed that comprises a housing having a longitudinal axis and including a base, a top, and a sidewall extending between the base and the top of the housing. A battery cell stack and a dynamic enclosure are supported on the base of the housing. The battery cell stack includes a plurality of battery cells stacked relative to one another along the longitudinal axis of the housing. The plurality of battery cells is physically separated into a first battery cell group that includes at least two adjacent battery cells and a second battery cell group that includes at least two adjacent battery cells. The dynamic enclosure includes first and second support walls and a canopy. The first and second support walls are respectively disposed on opposite first and second sides of the first battery cell group. Each of the first and second support walls includes a proximal end supported on the base of the housing and a distal end extending away from the base, above the first battery cell group. The canopy is coupled to the distal end of the first support wall and extends in a longitudinal direction parallel to the longitudinal axis of the housing. The canopy includes a free end that is configured to pivot about the distal end of the first support wall between a closed position, in which the free end of the canopy is supported on the distal end of the second support wall, and an open position in which an opening is defined between the free end of the canopy and the distal end of the second support wall. The dynamic enclosure defines an inner chamber within the housing. When the canopy is in the closed position, the dynamic enclosure establishes a physical and thermal barrier between the first battery cell group and the second battery cell group.

The canopy may be configured to transition from the closed position to the open position in response to a pressure increase within the inner chamber.

A gap may be defined in the housing between the battery cell stack and the sidewall of the housing. When the canopy is in the closed position, emissions from the first battery cell group may be directed through the inner chamber in a transverse direction perpendicular to the longitudinal axis of the housing into the gap.

A plenum may be defined in the housing between an upper end of the battery cell stack and the top of the housing. When the canopy is in the open position, emissions from the first battery cell group may be directed from the inner chamber, through the opening, and into the plenum.

The plenum may be in fluid communication with a vent in the top of the housing. When the canopy is in the open position, the canopy may direct the emissions in the plenum to flow in a longitudinal direction parallel to the longitudinal axis of the housing toward the vent.

The distal end of the second support wall may include a cantilever that extends in a longitudinal direction from the distal end of the second support wall toward the first support wall. When the canopy is in the closed position, the free end of the canopy may be supported on the cantilever.

The cantilever may be coupled to the distal end of the second support wall and may be configured to pivot about the distal end of the second support wall from a closed position to an open position in response to a pressure increase within the inner chamber. The canopy may have a first length and the cantilever may have a second length. A ratio of the first length of the canopy to the second length of the cantilever may be selected to control a first amount of emissions directed through the inner chamber in a transverse direction perpendicular to the longitudinal axis of the housing with respect to a second amount of emissions directed through the opening and in a longitudinal direction through the housing.

A battery is disclosed that comprises a housing including a base and a battery cell stack supported on the base of the housing. The battery cell stack includes a plurality of battery cells stacked relative to one another along a thickness direction thereof. A partition physically separates the plurality of battery cells into a first battery cell group and a second battery cell group. A first enclosure is supported on the base of the housing that forms a physical and thermal barrier on three sides of the first battery cell group. A second enclosure is supported on the base of the housing that forms a physical and thermal barrier on three sides of the second battery cell group. Each of the first and second enclosures includes: first and second support walls and a canopy. The first and second support walls have proximal ends supported on the base of the housing and distal ends extending away from the base, above the plurality of battery cells. The canopy extends between the distal ends of the first and second support walls.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

Illustrative embodiments will hereinafter be described in conjunction with the appended drawings, wherein like designations denote like elements, and wherein:

FIG. 1 is a schematic perspective view of a rechargeable battery for an electric vehicle, the battery including a battery cell stack disposed within a housing and including a plurality of battery cells separated into first and second battery cell groups by a partition.

FIG. 2 is a schematic perspective view of an electric vehicle including the rechargeable battery of FIG. 1.

FIG. 3 is a schematic side-sectional view of the rechargeable battery of FIG. 1, wherein the battery includes a first enclosure that partially surrounds the first battery cell group on three sides and a second enclosure that partially surrounds the second battery cell group on three sides.

FIG. 4 is a schematic side-sectional view of the rechargeable battery of FIG. 1, wherein the first and second battery cell groups are respectively enclosed within first and second dynamic enclosures, with each of the first and second dynamic enclosures including first and second support walls and a canopy hingedly coupled to the first support wall.

FIG. 5 is a schematic side-sectional view of the rechargeable battery of FIG. 1, wherein the first and second battery cell groups are respectively enclosed within first and second dynamic enclosures, with each of the first and second dynamic enclosures including first and second support walls, a canopy hingedly coupled to the first support wall, and a cantilever extending from the second support wall.

FIG. 6 is a schematic side-sectional view of the rechargeable battery of FIG. 1, wherein the first and second battery cells groups are respectively enclosed within first and second dynamic enclosures, with each of the first and second dynamic enclosures including first and second support walls, a canopy hingedly coupled to a distal end of the first support wall, and a flange extending from a distal end of the second support wall.

FIG. 7 is a schematic side-sectional view of the rechargeable battery of FIG. 1, wherein the first and second battery cells groups are respectively enclosed within first and second dynamic enclosures, with each of the first and second dynamic enclosures including first and second support walls, a canopy hingedly coupled to the first support wall, and with a distal end of the second support wall having a hemmed end.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

The presently disclosed enclosures may be incorporated into batteries that include multiple individual battery cell groups to help physically and thermally isolate the individual battery cell groups from one another. In situations where hot gases and/or hot particulate matter are emitted from one or more of the battery cell groups, the enclosures are configured to protect other battery cell groups from exposure to the hot emissions, for example, by containing the emissions within the enclosure or by dynamically directing the emissions away from the battery cell groups and out of the battery.

In the following text, the term “battery” means a device that includes multiple interconnected electrochemical cells (battery cells) arranged in series and/or parallel and may refer to battery cells that are grouped together, e.g., in stacks, to form battery modules and/or battery packs.

The term “about” means “within acceptable manufacturing tolerances” or “within 0-5% of.”

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the drawing figures. Spatially relative terms may be intended to encompass different orientations of the device or system in use or operation in addition to the orientation depicted in the drawing figures.

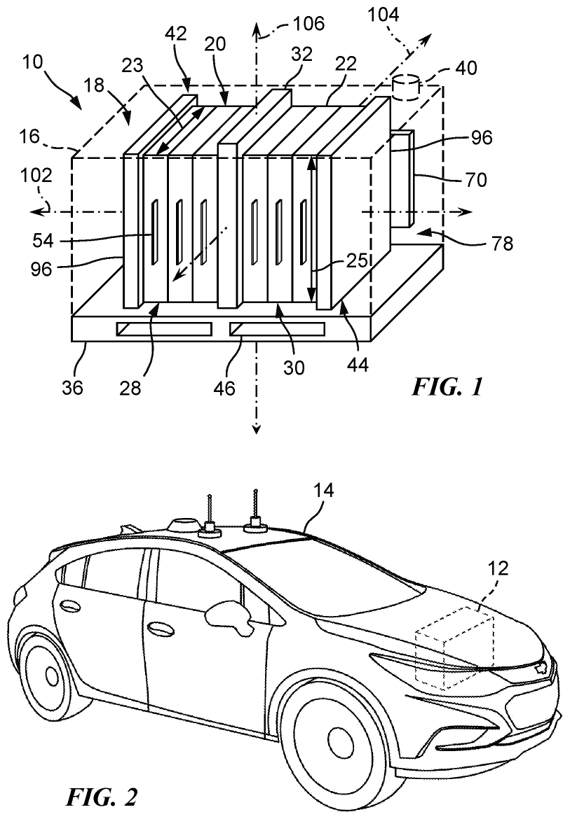

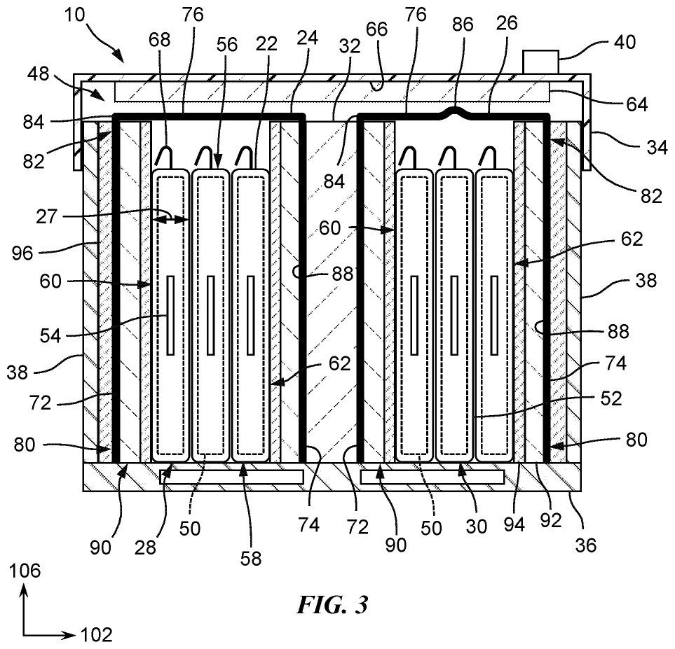

FIG. 1 depicts a battery 10 that may be used in an electric power supply 12 of a vehicle 14, such as an electric vehicle (EV) or a hybrid electric vehicle (HEV), as shown in FIG. 2. The battery 10 includes a housing 16 having a longitudinal axis that extends in a longitudinal direction 102. The housing 16 at least partially defines an interior 18 and a battery cell stack 20 is disposed within the interior 18 of the housing 16. The battery cell stack 20 includes multiple battery cells 22 stacked relative to one another along the longitudinal axis of the housing 16. Each of the battery cells 22 has a length 23 extending in a transverse direction 104, perpendicular to the longitudinal direction 102, a height 25 extending in a vertical direction 106, perpendicular to the longitudinal direction 102, and a thickness 27 (FIG. 3) extending in the longitudinal direction 102. The battery cells 22 in the battery cell stack 20 may be stacked relative to one another along a thickness direction thereof, which, in FIGS. 1 and 3, is parallel to the longitudinal direction 102.

The battery cells 22 in the battery cell stack 20 are separated into first and second battery cell groups 28, 30 by a partition 32. As shown in FIG. 3, each of the first and second battery cell groups 28, 30 includes an upper end 56, an opposite lower end 58, a first side 60 and an opposite second side 62. The first and second battery cell groups 28, 30 are physically and thermally isolated from one another by respective first and second enclosures 24, 26 that extend along the first and second sides 60, 62 of the first and second battery cell groups 28, 30 and above the upper ends 56 of the battery cell groups 28, 30.

In FIG. 1, the battery cell stack 20 includes six (6) battery cells 22 that are separated into groups of three (3); however, the number of battery cells 22 in the battery cell stack 20 may be less than or greater than six and/or the number of battery cells 22 in the first battery cell group 28 and/or the second battery cell group 30 may be less than or greater than three. In addition, in FIG. 1, the battery cell stack 20 includes the first and second battery cell groups 28, 30; however, the number of battery cell groups in the battery cell stack 20 may be less than or greater than two, with adjacent pairs of battery cell groups being separated from one another by partitions.

The housing 16 is configured to support the battery cell stack 20 within the vehicle 14 and to protect the battery cell stack 20 from exposure to ambient environmental conditions. As best shown in FIG. 3, the housing 16 includes a top 34, a base 36, and at least one end wall 38 extending between the top 34 and the base 36 of the housing 16. In aspects, a vent 40 may be in the top 34 of the housing 16 that facilitates pressure-induced venting of hot gases and/or particulate matter from the interior 18 of the housing 16. In aspects, the base 36 of the housing 16 may be in the form of a heatsink that is configured to transfer thermal energy (i.e., heat) away from the battery cell stack 20 to a heat transfer fluid (e.g., air or a liquid coolant) during operation of the battery 10. In such case, one or more passageways 46 may be defined in the base 36 of the housing 16 that facilitate a continuous flow of the heat transfer fluid therethrough during operation of the battery 10. A thermally insulating pad 64 may be positioned between the top 34 of the housing 16 and the battery cell stack 20. In aspects, the thermally insulating pad 64 may be carried on an underside 66 of the top 34 of the housing 16. The housing 16 may be made of a thermally conductive material to allow heat to dissipate away from the battery cell stack 20 during operation. The housing 16 may be made of a metal or a polymeric material having high thermal conductivity. For example, the housing 16 may be made of aluminum (Al) and/or copper (Cu). The term “metal,” as used herein, refers to materials made of a single elemental metal, as well as materials made of a mixture of two or more elements, wherein at least one of the elements is a metal. The other element(s) can be a non-metal or a different metal.

The battery cell stack 20 includes an upper end 42 adjacent the top 34 of the housing and a lower end 44 supported on and in thermal contact with the base 36 of the housing 16. The battery cell stack 20 is disposed within the interior 18 of the housing 16 such that the battery cell stack 20 is spaced-apart from the top 34 of the housing 16. For example, as best shown in FIG. 3, the battery cell stack 20 is disposed within the interior 18 of the housing 16 such that a plenum 48 is defined between the top 34 of the housing 16 and the upper end 42 of the battery cell stack 20. The battery cell stack 20 may be disposed within the interior 18 of the housing 16 such that the battery cell stack 20 is spaced-apart from a sidewall (not shown) of the housing 16. For example, as shown in FIG. 1, the battery cell stack 20 may be disposed within the interior 18 of the housing 16 such that a gap 78 is defined between a sidewall of the housing 16 and the battery cell stack 20.

Each of the battery cells 22 in the battery cell stack 20 includes an electrode assembly 50 (including a separator sandwiched between a positive electrode and a negative electrode) infiltrated with an electrolyte (not shown) and sealed within a case 52. Electrically conductive positive and negative electrode tabs 54 are electrically coupled to the electrode assembly 50 and extend from the electrode assembly 50 outside the case 52. The case 52 of each of the battery cells 22 may be formed and/or sealed around the electrode assembly 50 by laminating two sheets of polymeric material together along a periphery thereof. After the electrode assembly 50 is sealed within the case 52, the case 52 of each of the battery cells 22 may include a thin and flexible laminated portion 68 that extends along a periphery thereof. To help avoid physical contact between the laminated portion 68 of the case 52 and other adjacent components of the battery 10, the laminated portion 68 may be bent over upon itself, away from the top 34 of the housing 16.

The battery cells 22 may be lithium battery cells. For example, the battery cells 22 may be pouch-type lithium battery cells. In other aspects, the battery cells 22 may be prismatic or can-type lithium-ion battery cells.

In assembly, the battery cells 22 of the battery cell stack 20 may be electrically coupled to a battery management system (BMS) 70 (FIG. 1), which may include one or more integrated circuits (ICs) configured to measure certain operating parameters of the battery cells 22 (e.g., cell voltage and/or temperature), to control operation of the battery cells 22 (e.g., charging and discharging), and/or to couple the battery cells 22 to the electric power supply 12 of the vehicle 14 and/or to an external power source. As shown in FIG. 1, in aspects, the battery management system 70 may be positioned within the interior 18 of the housing 16 between the battery cell stack 20 and a sidewall (not shown) of the housing 16. Or the battery management system 70 may be positioned outside of the housing 16 and supported by the top 34 or the end wall 38 of the housing 16.

Referring now to FIG. 3, the first and second enclosures 24, 26 physically and thermally isolate the first and second battery cell groups 28, 30 from one another and from other components of the battery 10. The first and second enclosures 24, 26 partially surround the first and second battery cell groups 28, 30, with the first enclosure 24 extending over the upper end 56 and along the first and second sides 60, 62 of the first battery cell group 28 and the second enclosure 26 extending over the upper end 56 and along the first and second sides 60, 62 of the second battery cell group 30. Each of the first and second enclosures 24, 26 includes a pair of first and second support walls 72, 74 and a canopy 76 that extends between the first and second support walls 72, 74, above the upper ends 56 of the first and second battery cell groups 28, 30. The first and second support walls 72, 74 are respectively disposed on the first and second sides 60, 62 of the first and second battery cell groups 28, 30. Each of the first and second support walls 72, 74 has a proximal end 80 supported on the base 36 of the housing 16 and a distal end 82 extending in a vertical direction 106 away from the base 36, above the battery cells 22.

In FIG. 3, the canopy 76 of each of the first and second enclosures 24, 26 is fixedly attached to the distal ends 82 of the first and second support walls 72, 74. In aspects, flexible joints 84 may be formed between the distal ends 82 of the first and second support walls 72, 74 and the canopy 76 to allow for easy opening and closing of the first and second enclosures 24, 26 during assembly of the battery 10, i.e., during stacking of the battery cells 22 in the battery cell stack 20.

The first and second enclosures 24, 26 may be of unitary, one-piece construction. In such case, the first and second enclosures 24, 26 may be formed from a single sheet of material and bent into the desired shape of the first and second enclosures 24, 26. The first and second enclosures 24, 26 may be made of a rigid, structural material that is capable of retaining its physical shape and mechanical strength when exposed to high temperatures, e.g., temperatures experienced during a thermal runaway event. The first and second enclosures 24, 26 may be made of a material that is capable of being formed into the shape of the first and second enclosures 24, 26, for example, by bending. For example, the first and second enclosures 24, 26 may be made of metal, e.g., stainless steel. In aspects where the first and second enclosures 24, 26 are made of an electrically conductive material (e.g., metal), exterior surfaces of the first and second enclosures 24, 26 may be laminated or coated with a layer of electrically insulating material.

The canopy 76 of the first enclosure 24 is substantially flat. On the other hand, the canopy of the second enclosure 26 includes a corrugation 86. Formation of one or more corrugations 86 in the canopy 76 of the first or second enclosure 24, 26 may allow the canopy 76 to stretch in the longitudinal direction 102 at the corrugation 86 to accommodate increases in the thickness 27 of one or more of the battery cells 22 over the life of the battery 10. In the event a compressive force is exerted on the first and second support walls 72, 74 in the longitudinal direction 102, the corrugation 86 may help the second enclosure 26 to absorb the impact, for example, by allowing the second enclosure 26 to compress in the longitudinal direction 102 at the corrugation 86.

The proximal ends 80 of the first and second support walls 72, 74 may be biased toward each other. In such case, the first and second support walls 72, 74 may exert pressure in the longitudinal direction 102 respectively on the first and second sides 60, 62 of the first and second battery cell groups 28, 30, which may assist in stacking of the battery cells 22 in the battery cell stack 20 during assembly of the battery 10. In aspects where the first and second enclosures 24, 26 are made of metal, the first and second support walls 72, 74 may be biased toward each other by the inherent tensile and compressive stresses imparted on the metal when the metal is bent from a flat sheet to the shape of the first and second enclosures 24, 26.

Laminate structures 90 may be disposed along inner surfaces 88 of the first and second support walls 72, 74, between the first and second support walls 72, 74 and the first and second sides 60, 62 of the first and second battery cell groups 28, 30. Each of the laminate structures 90 may include a thermally insulating layer 92 disposed on the inner surface 88 of the first or second support wall 72, 74 and a compression layer 94 disposed on the first or second support wall 72, 74 over the thermally insulating layer 92. In aspects, the laminate structures 90 disposed on the inner surfaces 88 of the first and second support walls 72, 74 may include one or more additional layers and or different materials, as desired.

The partition 32 may provide a thermal and physical barrier between the first and second battery cell groups 28, 30 and may be made of a thermally insulating material.

Compression pads 96 may be disposed on opposite ends of the battery cell stack 20, between the end walls 38 and the first and second enclosures 24, 26. The compression pads 96 may provide a layer of cushioning between the battery cell stack 20 and the end wall 38 of the housing 16 and may help protect the battery cells 22 from external impacts, assist during assembly of the battery cell stack 20, and/or help compensate for volumetric changes in the battery cells 22 over the life of the battery 10.

The size (i.e., the length and height) of the laminate structures 90, the partition 32, and the compression pads 96 may be commensurate with or larger than the length 23 and the height 25 of the facing surfaces of the battery cells 22 to help ensure even pressure distribution along the facing surfaces thereof.

During a thermal runaway event, the first and second enclosures 24, 26 may inhibit propagation of thermal runaway temperatures throughout the battery 10. For example, in aspects, the first and second enclosures 24, 26 may help contain hot gases and/or particulate matter emitted from the first and/or second battery cell groups 28, 30 within the first and second enclosures 24, 26. In addition, the first and second enclosures 24, 26 may help direct emissions from the first and/or second battery cell groups 28, 30 in a transverse direction 104 toward the gap 78 between the battery cell stack 20 and the sidewall of the housing 16. In aspects, emissions the first and/or second battery cell groups 28, 30 may be directed in the transverse direction 104 toward the vent 40 in the top 34 of the housing 16.

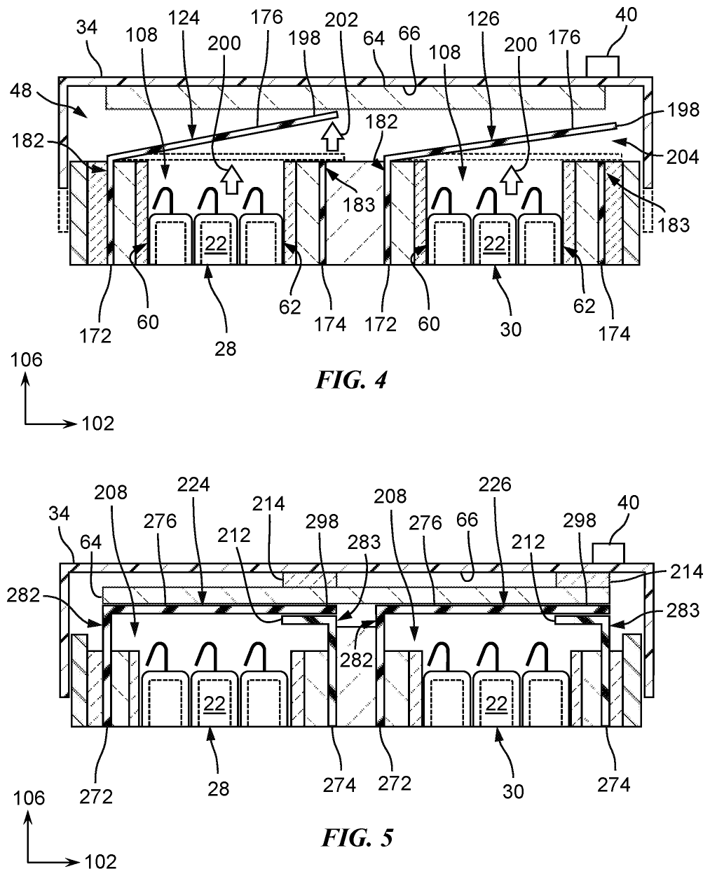

Referring now to FIG. 4, in aspects, the battery 10 may include a pair of first and second dynamic enclosures 124, 126. The first and second dynamic enclosures 124, 126 are similar in many respects to the first and second enclosures 24, 26 depicted in FIGS. 1 and 3, and a description of common subject matter generally may not be repeated here. Each of the first and second dynamic enclosures 124, 126 includes a pair of first and second support walls 172, 174 and a canopy 176 that together define an inner chamber 108. The first and second support walls 172, 174 are respectively disposed on the first and second sides 60, 62 of the first and second battery cell groups 28, 30. The first and second support walls 172, 174 of the first and second dynamic enclosures 124, 126 have proximal ends (not shown) supported on the base 36 of the housing 16 and respective distal ends 182, 183 extending in a vertical direction 106 toward the top 34 of the housing 16, above the battery cells 22. The first and second dynamic enclosures 124, 126 may be made of the same material(s) as that of the first and second enclosures 24, 26 may be formed by the same manufacturing processes.

Each canopy 176 of the first and second dynamic enclosures 124, 126 is hingedly coupled to the distal end 182 of the first support wall 172 and has a free end 198 that is configured to pivot about the distal end 182 of the first support wall 172 to transition the canopy 176 from a closed position (dashed lines) to an open position. For example, each canopy 176 of the first and second dynamic enclosures 124, 126 may be coupled to the distal end 182 of the first support wall 172 by a hinge or by other means that allows the free end 198 of the first support wall 172 to pivot about the distal end 182 of the first support wall 172, as shown in FIG. 4. When the canopy 176 of each of the first and second dynamic enclosures 124, 126 is in the closed position, each canopy 176 is oriented in a substantially horizontal position, the free end 198 of the canopy 176 is supported on the distal end 183 of the second support wall 174, the first battery cell group 28 is sealed and/or enclosed within the inner chamber 108 defined by the first dynamic enclosure 124, and the second battery cell group 30 is sealed and/or enclosed within the inner chamber 108 defined by the second dynamic enclosure 126.

The canopy 176 of each of the first and second dynamic enclosures 124, 126 may be biased toward the closed position and may be configured to pivot about the distal end 182 of the first support wall 172 to the open position, for example, in response to an increase in pressure within the inner chamber 108. The canopy 176 of each of the first and second dynamic enclosures 124, 126 may be biased toward the closed position, for example, by pressure exerted on the canopy 176 by the top 34 of the housing 16. In aspects where the canopy 176 is made of a metal, the canopy 176 may be biased toward the closed position by the inherent tensile and compressive stresses imparted on the metal when the metal is bent from a flat sheet to the shape of the first support wall 172.

When the first support wall 172 is in the open position, an opening 204 is defined between the distal end 183 of the second support wall 174 through which hot gases and/or particulate matter in the inner chamber 108 may be released. In situations where one or more of the battery cells 22 of the first and/or second battery cell group 28, 30 is undergoing thermal runaway and emitting hot gases and/or particulate matter, the force 200 exerted on the canopy 176 may cause the free end 198 of the canopy 176 to pivot about the distal end 182 of the first support wall 172 to the open position. When the canopy 176 is in the open position, emissions from the first and/or second battery cell groups 28, 30 may be directed through the opening 204 and into the plenum 48. In the plenum 48, the canopy 176 may direct the emissions to flow in a longitudinal direction 102 toward the vent 40. In situations where the first battery cell group 28 is emitting hot gases and/or particulate matter (e.g., undergoing thermal runaway) and the second battery cell group 30 is operating normally, the increased pressure in the inner chamber 108 defined by the first dynamic enclosure 124 may cause the canopy 176 to pivot to the open position so that the emissions may be released therefrom. At the same time, the canopy 176 of the second dynamic enclosure 126 may be retained in the closed position, thereby maintaining a physical and thermal barrier around the second battery cell group 30.

When the canopy 176 transitions from the closed position to the open position, the free end 198 of the canopy 176 may exert a force 202 on the underside 66 of the top 34 of the housing 16. The force 202 exerted on the underside 66 of the top 34 of the housing 16 by the canopy 176 may cause the top 34 of the housing 16 to slide or move in a vertical direction 106 along the end walls 38 of the housing 16 and lift further away from the base 36.

During normal operation of the battery 10, the top 34 of the housing 16 (or the thermally insulating pad 64) may rest against the canopy 176 of the first and second dynamic enclosures 124, 126 and, in aspects, may help maintain the canopy 176 in the closed position so that emissions from the first and/or second battery cell groups 28, 30 are retained within the inner chambers 108. Pressure exerted on the top 34 of the housing 16 may be transferred to the first and second support walls 172, 174 of the first and second dynamic enclosures 124, 126 and through the first and second support walls 172, 174 to the base 36 of the housing 16, which may help protect and prevent physical damage to the battery cells 22 of the first and second battery cell groups 28, 30.

Referring now to FIG. 5, in aspects, the battery 10 may include a pair of first and second dynamic enclosures 224, 226. The first and second dynamic enclosures 224, 226 are similar in many respects to the first and second dynamic enclosures 124, 126 depicted in FIG. 4, and a description of common subject matter generally may not be repeated here. Each of the first and second dynamic enclosures 224, 226 includes a pair of first and second support walls 272, 274 and a canopy 276 that together define an inner chamber 208. The first and second support walls 272, 274 of the first and second dynamic enclosures 224, 226 have proximal ends (not shown) supported on the base 36 of the housing 16 and respective distal ends 282, 283 extending in a vertical direction 106 toward the top 34 of the housing 16, above the battery cells 22. Each canopy 276 of the first and second dynamic enclosures 224, 226 is hingedly coupled to the distal end 282 of the first support wall 272 and has a free end 298 that is configured to pivot about the distal end 282 of the first support wall 272 to transition the canopy 276 from a closed position (FIG. 5) to an open position (not shown).

In FIG. 5, the distal end 283 of each of the second support walls 274 includes a cantilever 212 that is oriented in a horizontal position and extends in a longitudinal direction 102 from the distal end 283 of the second support wall 274 toward the first support wall 272. When the canopy 276 is in the closed position, the canopy 276 may overlap the cantilever 212. The cantilever 212 may be configured to support the free end 298 of the canopy 276 when the canopy 276 is in the closed position. To help direct forces exerted on the top 34 of the housing 16 to the first and second support walls 172, 174, a spacer 214 may be positioned between the cantilever 212 and the top 34 of the housing 16. For example, as shown in FIG. 5, the spacer 214 may be positioned in vertical alignment with the cantilever 212 between the underside 66 of the top 34 of the housing 16 and the thermally insulating pad 64. Additional or alternatively, the spacer 214 may be positioned in vertical alignment with the cantilever 212 and disposed between the thermally insulating pad 64 and the canopy 276.

In aspects, the cantilever 212 may be hingedly coupled to the distal end 283 of the second support wall 274 and may be configured to pivot about the distal end 283 of the second support wall 274 to transition from a closed position (FIG. 5) to an open position (not shown). In such case, the length of the cantilever 212 may be selected to control the amount of emissions released from the inner chamber 208 when the canopy 276 and the cantilever 212 are in the open position.

In aspects, the cantilever 212 may be fixedly attached to the free end 298 of the canopy 276 after assembly of the battery cell stack 20, for example, using an adhesive.

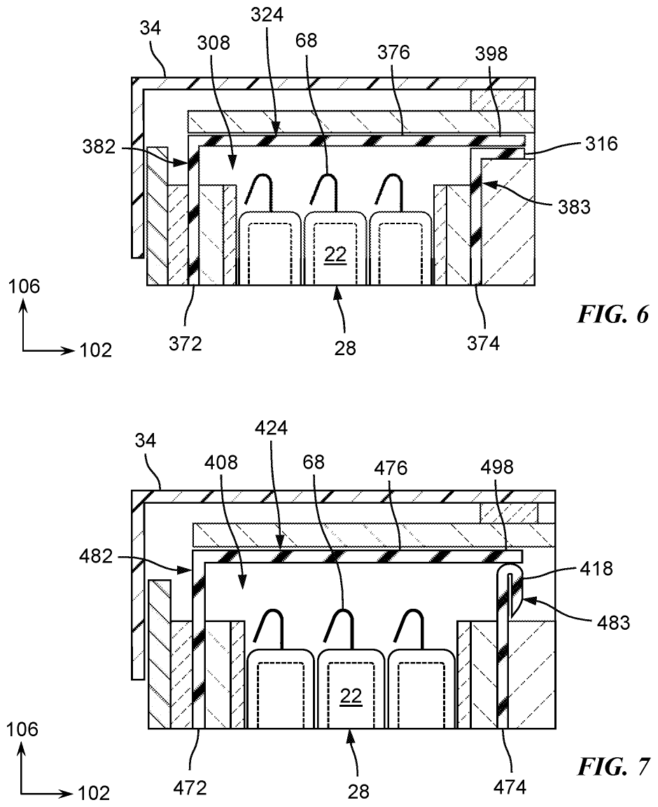

Referring now to FIG. 6, in aspects, the battery 10 may include one or more dynamic enclosures 324. The dynamic enclosure 324 is similar in many respects to the first and second dynamic enclosures 224, 226 depicted in FIG. 5, and a description of common subject matter generally may not be repeated here. The dynamic enclosure 324 includes a pair of first and second support walls 372, 374 and a canopy 376 that together define an inner chamber 308. The first and second support walls 372, 374 of the dynamic enclosure 324 have proximal ends (not shown) supported on the base 36 of the housing 16 and respective distal ends 382, 383 extending in a vertical direction 106 toward the top 34 of the housing 16, above the battery cells 22.

The canopy 376 of the dynamic enclosure 324 is hingedly coupled to the distal end 382 of the first support wall 372 and has a free end 398 that is configured to pivot about the distal end 382 of the first support wall 372 to transition the canopy 376 from a closed position (FIG. 6) to an open position (not shown).

In FIG. 6, the distal end 383 of the second support wall 374 includes a flange 316 that is oriented in a horizontal position and extends in a longitudinal direction 102 from the distal end 383 of the second support wall 374 away from the first support wall 372. The flange 316 may be configured to support the free end 398 of the canopy 376 when the canopy 376 is in the closed position and, in assembly, may allow for additional vertical clearance above the laminated portions 68 of the battery cells 22.

Referring now to FIG. 7, in aspects, the battery 10 may include one or more dynamic enclosures 424. The dynamic enclosure 424 is similar in many respects to the dynamic enclosure 324 depicted in FIG. 6, and a description of common subject matter generally may not be repeated here. The dynamic enclosure 424 includes a pair of first and second support walls 472, 474 and a canopy 476 that together define an inner chamber 408. The first and second support walls 472, 474 of the dynamic enclosure 424 have proximal ends (not shown) supported on the base 36 of the housing 16 and respective distal ends 482, 483 extending in a vertical direction 106 toward the top 34 of the housing 16, above the battery cells 22.

The canopy 476 of the dynamic enclosure 424 is hingedly coupled to the distal end 482 of the first support wall 472 and has a free end 498 that is configured to pivot about the distal end 482 of the first support wall 472 to transition the canopy 476 from a closed position (FIG. 7) to an open position (not shown).

In FIG. 7, the distal end 483 of the second support wall 474 includes a hemmed edge 418. The hemmed edge 418 may be configured to support the free end 498 of the canopy 476 when the canopy 476 is in the closed position and, in assembly, may allow for additional vertical clearance above the laminated portions 68 of the battery cells 22.

These and other benefits will be readily appreciated by those of ordinary skill in the art in view of the forgoing disclosure.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. A battery comprising:
a housing having a longitudinal axis and including a base;
a battery cell stack supported on the base of the housing, the battery cell stack including a plurality of battery cells stacked relative to one another along a thickness direction thereof, the plurality of battery cells being physically separated into a first battery cell group and a second battery cell group; and
an enclosure supported on the base of the housing, the enclosure including:
first and second support walls respectively disposed on opposite first and second sides of the first battery cell group, each of the first and second support walls including a proximal end supported on the base of the housing and a distal end extending away from the base, above the plurality of battery cells; and
a canopy extending between the distal ends of the first and second support walls, above the first battery cell group,
wherein the enclosure defines an inner chamber within the housing, and
wherein the enclosure partially surrounds the first battery cell group on three sides and establishes a physical and thermal barrier between the first battery cell group and the second battery cell group.

2. The battery of claim 1 wherein the canopy includes a first end and an opposite second end, and wherein the first end of the canopy is fixedly attached to the distal end of the first support wall and the second end of the canopy is fixedly attached to the distal end of the second support wall.

3. The battery of claim 2 wherein the proximal ends of the first and second support walls are biased toward each other such that the first and second support walls exert pressure in a longitudinal direction respectively on the first and second sides of the first battery cell group.

4. The battery of claim 2 wherein the housing includes a top and at least one sidewall extending between the base and the top of the housing, wherein a gap is defined between the battery cell stack and the at least one sidewall of the housing, and wherein, emissions from the first battery cell group are directed through the inner chamber in a transverse direction perpendicular to the longitudinal axis of the housing into the gap.

5. The battery of claim 1 wherein the first and second support walls and the canopy are of unitary one-piece construction.

6. The battery of claim 5 wherein the canopy includes a corrugation that allows the canopy to stretch or compress in a longitudinal direction at the corrugation.

7. The battery of claim 1 wherein the first and second support walls are moveably supported on the base of the housing such that the first and second support walls are moveable in a longitudinal direction relative to one another on the base to accommodate volumetric changes in the plurality of battery cells.

8. The battery of claim 1 wherein the canopy is coupled to the distal end of the first support wall and extends from the distal end of the first support wall in a longitudinal direction parallel to the longitudinal axis of the housing to a free end, wherein the free end of the canopy is configured to pivot about the distal end of the first support wall between a closed position, in which the free end of the canopy is supported on the distal end of the second support wall, and an open position in which an opening is defined between the free end of the canopy and the distal end of the second support wall.

9. The battery of claim 8 wherein the distal end of the second support wall includes one of:
a cantilever that extends in a longitudinal direction from the distal end of the second support wall toward the first support wall, and wherein, when the canopy is in the closed position, the free end of the canopy is supported on the cantilever;
a flange that extends in a longitudinal direction from the distal end of the second support wall away from the first support wall, and wherein, when the canopy is in the closed position, the free end of the canopy is supported on the flange; or
a hemmed end, and wherein, when the canopy is in the closed position, the free end of the canopy is supported on the hemmed end.

10. The battery of claim 8 wherein the canopy is biased toward the closed position and against the distal end of the second support wall, and wherein the canopy is configured to transition from the closed position to the open position in response to a pressure increase within the inner chamber.

11. The battery of claim 10 wherein the housing includes a top and at least one sidewall extending between the base and the top of the housing, wherein a plenum is defined in the housing between an upper end of the battery cell stack and the top of the housing, and wherein, when the canopy is in the open position, emissions from the first battery cell group are directed from the inner chamber, through the opening, and into the plenum.

12. The battery of claim 11 wherein the plenum is in fluid communication with a vent in the top of the housing, and wherein, when the canopy is in the open position, the canopy directs the emissions in the plenum to flow in a longitudinal direction parallel to the longitudinal axis of the housing toward the vent.

13. A battery comprising:
a housing having a longitudinal axis and including a base, a top, and a sidewall extending between the base and the top of the housing;
a battery cell stack supported on the base of the housing, the battery cell stack including a plurality of battery cells stacked relative to one another along the longitudinal axis of the housing, the plurality of battery cells being physically separated into a first battery cell group that includes at least two adjacent battery cells and a second battery cell group that includes at least two adjacent battery cells; and
a dynamic enclosure including:
first and second support walls respectively disposed on opposite first and second sides of the first battery cell group, each of the first and second support walls including a proximal end supported on the base of the housing and a distal end extending away from the base, above the first battery cell group; and
a canopy coupled to the distal end of the first support wall, the canopy extending in a longitudinal direction parallel to the longitudinal axis of the housing and including a free end that is configured to pivot about the distal end of the first support wall between a closed position, in which the free end of the canopy is supported on the distal end of the second support wall, and an open position in which an opening is defined between the free end of the canopy and the distal end of the second support wall,
wherein the dynamic enclosure defines an inner chamber within the housing, and
wherein, when the canopy is in the closed position, the dynamic enclosure establishes a physical and thermal barrier between the first battery cell group and the second battery cell group.

14. The battery of claim 13 wherein the canopy is configured to transition from the closed position to the open position in response to a pressure increase within the inner chamber.

15. The battery of claim 13 wherein a gap is defined in the housing between the battery cell stack and the sidewall of the housing, and wherein, when the canopy is in the closed position, emissions from the first battery cell group are directed through the inner chamber in a transverse direction perpendicular to the longitudinal axis of the housing into the gap.

16. The battery of claim 13 wherein a plenum is defined in the housing between an upper end of the battery cell stack and the top of the housing, and wherein, when the canopy is in the open position, emissions from the first battery cell group are directed from the inner chamber, through the opening, and into the plenum.

17. The battery of claim 16 wherein the plenum is in fluid communication with a vent in the top of the housing, and wherein, when the canopy is in the open position, the canopy directs the emissions in the plenum to flow in a longitudinal direction parallel to the longitudinal axis of the housing toward the vent.

18. The battery of claim 13 wherein the distal end of the second support wall includes a cantilever that extends in a longitudinal direction from the distal end of the second support wall toward the first support wall, and wherein, when the canopy is in the closed position, the free end of the canopy is supported on the cantilever.

19. The battery of claim 18 wherein the cantilever is coupled to the distal end of the second support wall and is configured to pivot about the distal end of the second support wall from a closed position to an open position in response to a pressure increase within the inner chamber, wherein the canopy has a first length and the cantilever has a second length, and wherein a ratio of the first length of the canopy to the second length of the cantilever is selected to control a first amount of emissions directed through the inner chamber in a transverse direction perpendicular to the longitudinal axis of the housing with respect to a second amount of emissions directed through the opening and in a longitudinal direction through the housing.

20. A battery comprising:
a housing including a base;
a battery cell stack supported on the base of the housing, the battery cell stack including a plurality of battery cells stacked relative to one another along a thickness direction thereof
a partition that physically separates the plurality of battery cells into a first battery cell group and a second battery cell group;
a first enclosure supported on the base of the housing that forms a physical and thermal barrier on three sides of the first battery cell group; and
a second enclosure supported on the base of the housing that forms a physical and thermal barrier on three sides of the second battery cell group,
wherein, each of the first and second enclosures includes:
first and second support walls having proximal ends supported on the base of the housing and distal ends extending away from the base, above the plurality of battery cells; and
a canopy extending between the distal ends of the first and second support walls.
